(19) United States
(12) Patent Application Publication
(10) Pub. No.: US 2026/0244614 A1
(43) Pub. Date: Aug. 20, 2026

(54) SYSTEMS AND METHODS FOR AGENTIC GENERATION AND ADAPTIVE REFINEMENT OF DATA-DRIVEN PRESENTATION CONTENT

(71) Applicant: Target Brands, Inc., Minneapolis, MN (US)

(72) Inventors: Dakota Brown, St. Paul, MN (US); Adam Jerome Weintraut, Minneapolis, MN (US); Richard Yudhishthu, Minneapolis, MN (US); Vishal Vijay Shanker, Inver Grove Heights, MN (US)

(21) Appl. No.: 19/646,916

(22) Filed: Apr. 14, 2026

(51) Int. Cl. G06F 16/242; G06F 16/26; G06F 16/28

(52) U.S. Cl. CPC G06F 16/2425; G06F 16/26; G06F 16/285

(57) ABSTRACT

Systems and methods are disclosed for automated generation and adaptive refinement of data-driven presentation content using a multi-agent workflow architecture. A campaign processing system retrieves advertiser-level and campaign-level performance data, applies eligibility criteria to identify actionable opportunities, and generates structured presentation content including visualizations, narrative recommendations, and data tables organized into discrete content slots. Generated content is presented to a human reviewer for approval or rejection. Upon rejection, an adaptive feedback engine employing a large language model extracts structured feedback elements from unstructured user input and may iteratively request clarification. Structured feedback is aggregated at slot, advertiser, and program levels to selectively regenerate content and improve subsequent generation workflows

### BACKGROUND

Retail media platforms and enterprise advertising systems increasingly rely on data-driven insights to guide advertiser decision-making. In such environments, account managers or sales personnel routinely generate analytical “sales stories” that summarize campaign performance, identify optimization opportunities, and recommend changes intended to improve advertiser outcomes. These sales stories are commonly delivered in presentation formats (e.g., slide decks) and may incorporate advertiser-level metrics, campaign-level performance data, comparative analytics, and visualizations such as charts or tables.

Traditionally, the generation of these sales stories has required substantial manual effort. Account managers must retrieve data from multiple enterprise systems, analyze campaign performance across various metrics, determine eligibility for specific recommendations, generate visualizations, craft persuasive narrative text, and format the results into presentation-ready materials. This process can require multiple hours per story and must often be repeated across large advertiser portfolios on a recurring basis. As the number of advertiser accounts and campaign variations increases, the manual workload scales accordingly, creating operational bottlenecks and limiting the frequency and consistency of insight delivery.

Recent advances in large language models (LLMs) and generative artificial intelligence (AI) systems have enabled partial automation of content creation. However, existing approaches typically rely on monolithic prompt-based generation and lack structured architectures for integrating enterprise data, enforcing repeatable analytical standards, organizing presentation content into modular components, or incorporating user feedback in a systematic and scalable manner. Furthermore, conventional feedback mechanisms—such as static forms or free-text comments—often produce unstructured or incomplete feedback that is difficult to operationalize, thereby limiting continuous improvement of automated systems.

### SUMMARY

The present disclosure relates to systems and methods for agentic generation and adaptive refinement of data-driven presentation content. A multi-agent workflow retrieves multi-level data associated with a subject entity, filters the data using predefined eligibility criteria, generates visualizations and narrative elements based on predefined insight descriptions, and synthesizes the resulting components into structured presentation content organized into independently addressable content slots. The generated content is presented for human review, and rejection feedback is validated, structured, and operationalized using a large language model to enable selective regeneration and continuous improvement of subsequent content generation.

In one aspect, a computer-implemented system is provided for automated generation and refinement of structured presentation content, the system including a multi-agent content generation workflow comprising a data retrieval agent configured to retrieve multi-level data associated with a subject entity from one or more data sources, a filtering agent configured to apply eligibility criteria to identify qualifying data subsets, a visualization generation agent configured to generate one or more data visualizations based on predefined insight descriptions and the qualifying data subsets, and a synthesis agent configured to combine the qualifying data subsets, generated visualizations, and narrative text into structured presentation content. The system further includes a slot-based content architecture in which the structured presentation content is organized into discrete content slots that are independently addressable, a user interface configured to present the content and receive rejection of selected slots and associated unstructured feedback, a feedback validation engine configured to invoke a large language model to extract structured feedback, an iterative clarification module configured to generate contextual follow-up questions when validation criteria are not satisfied, and a feedback synthesis engine configured to aggregate structured feedback and modify future executions of the multi-agent workflow to implement a continuous improvement loop.

In another aspect, a computer-implemented method is provided for adaptive refinement of automatically generated presentation content, the method comprising generating structured presentation content using a multi-agent workflow in which the content comprises a plurality of independently addressable content slots, presenting the structured presentation content to a user, receiving rejection of one or more selected content slots and associated unstructured feedback, invoking a large language model to extract structured feedback from the unstructured feedback, iteratively generating contextual follow-up questions and re-validating feedback when predefined validation criteria are not satisfied, persisting the structured feedback, and modifying future executions of the multi-agent workflow based on aggregated structured feedback whereby structured feedback systematically improves subsequent content generation.

In a further aspect, a computer-implemented system is provided for validating and operationalizing user feedback regarding automatically generated presentation content, the system including a content presentation interface configured to display presentation content organized into discrete content slots and receive user selection of rejected slots and associated unstructured feedback, a feedback validation engine comprising a large language model configured to analyze the unstructured feedback in context of the rejected slots and conversation history and extract structured feedback including a summarized rejection reason, at least one rejection category selected from a predefined taxonomy, and a rejection perspective identifier, a validation module configured to determine whether predefined completeness and specificity criteria are satisfied, an iterative clarification module configured to generate contextual follow-up questions and re-invoke validation when criteria are not met, a feedback persistence layer configured to store structured feedback and associated metadata, and a selective regeneration engine configured to regenerate only rejected content slots while preserving non-rejected content slots, thereby enabling slot-level refinement without regenerating an entire presentation .

### BRIEF DESCRIPTION OF THE DRAWINGS

The accompanying drawings, which are incorporated herein and form a part of the specification, illustrate aspects of the present disclosure and, together with the description, serve to explain the principles thereof.

FIG. 1 illustrates an example system environment in which an enterprise user and a third-party user interact with a campaign processing system in communication with one or more data stores and a large language model (LLM).

FIG. 2 illustrates an example high-level process flow for automated insight generation and feedback handling.

FIG. 3 illustrates an example high-level system architecture for bulk insight generation and feedback processing.

FIG. 4 illustrates an example agent-based application architecture including routing components, specialized agents, data access components, and integration with external AI services and data stores.

FIG. 5 illustrates an example slot-based slide template architecture in which presentation content is organized into discrete content slots.

FIG. 6 illustrates an example feedback validation and clarification workflow.

FIG. 7 illustrates an example user interface for displaying an insight summary view including advertiser-level insight listings and status indicators.

FIG. 8 illustrates an example user interface for reviewing individual generated insights and approving or rejecting recommendations at a slot level.

FIG. 9 illustrates an example user interface for collecting and displaying structured feedback associated with rejected insight content.

FIG. 10 illustrates an example computing system including one or more processors, memory, storage, and networking components suitable for implementing the systems and methods described herein.

### DETAILED DESCRIPTION

Embodiments of the present invention are directed to systems and methods for automated generation and refinement of data-driven presentation content using a multi-agent workflow architecture combined with an adaptive feedback validation and synthesis system.

In one aspect, a multi-agent content generation workflow is provided. The workflow includes a plurality of specialized agents, such as: a data retrieval agent configured to query enterprise data sources and retrieve multi-level data frames, including advertiser-level aggregated metrics and campaign-level granular performance data; a filtering agent configured to apply eligibility criteria, such as temporal constraints and performance optimization potential, to identify qualifying data subsets; a visualization generation agent configured to generate data visualizations based on predefined insight descriptions and the retrieved data; and a synthesis agent configured to combine data elements, visualizations, and narrative text into structured presentation content.

In some embodiments, the generated presentation content is organized into a plurality of discrete, independently addressable content slots. Each slot may contain a visualization, a text field, or a data table, and is associated with metadata identifying slot type, content description, and slot position. The slot-based architecture enables modular construction of presentation materials and supports selective regeneration of individual content elements without affecting other slots.

In another aspect, the system includes a human-in-the-loop review interface that enables enterprise users (e.g., account managers) to approve or reject generated presentation content. Upon rejection, users may select one or more specific content slots and provide unstructured feedback via text or voice input.

An adaptive feedback validation engine, employing a large language model (LLM), analyzes the unstructured feedback and extracts structured feedback elements, including: a summarized rejection reason, at least one rejection category selected from a predefined taxonomy (e.g., template issue, data issue, content misalignment), and a rejection perspective identifier (e.g., account owner rejection versus anticipated advertiser rejection).

If the extracted feedback fails to satisfy predefined validation criteria—such as completeness or specificity—an iterative clarification module generates contextual follow-up questions based on conversation history. The system continues the clarification process until structured feedback is successfully extracted or a configurable maximum number of iterations is reached. In all cases, the system persists structured feedback and associated conversation history for downstream analysis.

In a further aspect, a feedback synthesis engine aggregates validated feedback across multiple levels of granularity, including: slot-level aggregation, to identify patterns associated with particular content slot types; advertiser-level aggregation, to identify subject-specific preferences and enable automated customization of future content generation; and program-level aggregation, to identify systematic quality issues and inform updates to agent instructions, insight descriptions, templates, or data pipelines.

Through this architecture, the system implements a continuous improvement loop in which structured feedback derived from rejected content is automatically synthesized and applied to enhance subsequent content generation. Improvements may include immediate slot regeneration with feedback-derived constraints, modification of agent prompts, update of visualization logic, or implementation of advertiser-specific customization rules.

In some embodiments, the multi-agent workflow executes as a batch process on a scheduled basis to generate presentation content for multiple advertiser accounts. The system may include an abstraction layer that decouples agent logic from specific LLM implementations, thereby enabling model substitution or upgrade without modifying upstream services. Advantageously, the disclosed systems and methods provide scalable automation of repeatable analytical sales stories, as well as modular, slot-based presentation construction. The systems and methods also provide adaptive, conversational validation of unstructured user feedback, as well as multi-level feedback synthesis enabling continuous, enterprise-scale quality improvement. These and other features and advantages of the invention will become apparent from the following detailed description and accompanying drawings.

The term “multi-level data” as used throughout this disclosure refers to hierarchically organized datasets retrieved by the data retrieval agent, wherein the data is structured into two or more distinct levels of granularity or aggregation, each level representing a different scope of analysis. In typical implementations, multi-level data includes at least a first aggregated level and a second granular level, where the first aggregated level presents summary statistics or rolled-up metrics calculated across multiple subordinate records, and the second granular level presents detailed, record-specific data for individual transactions, campaigns, products, or other analytical units. The multi-level data structure enables agents within the multi-agent workflow to reason at different levels of abstraction: higher-level aggregated data provides context, benchmarks, and entity-wide trends, while lower-level granular data enables identification of specific opportunities, outliers, or actionable items requiring targeted recommendations.

Additionally, as used throughout this disclosure, “predefined insight descriptions” refer to structured specifications, templates, or analytical blueprints that define the type, focus, and objectives of a particular category of data-driven recommendation or presentation content to be generated by the multi-agent workflow.

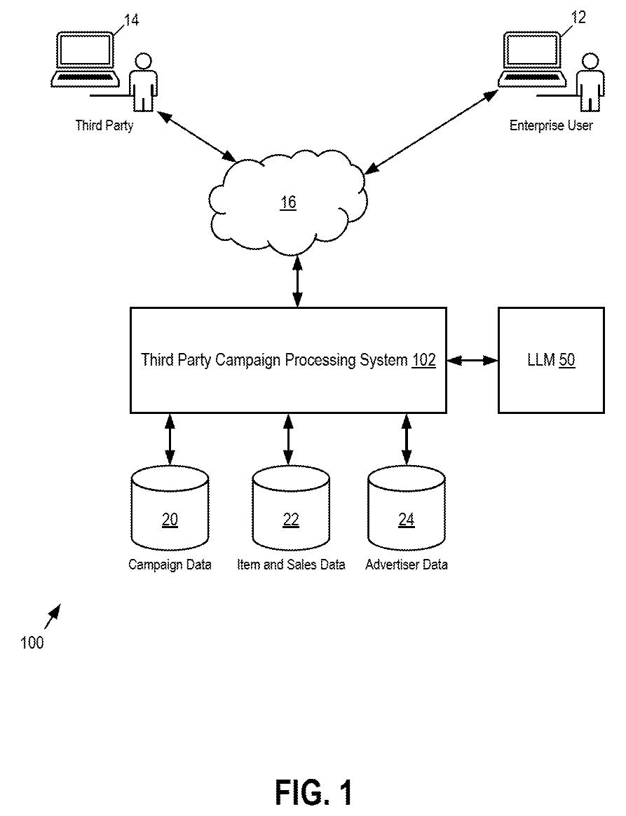

FIG. 1 illustrates an example system environment 100 in which an enterprise user 12 and a third-party advertiser user 14 interact with a third-party campaign processing system 102 in communication with one or more data stores and a large language model (LLM) 50, in accordance with embodiments of the present disclosure. The system environment 100 provides a technical framework for automated generation, validation, and refinement of data-driven presentation content, such as sales stories, campaign performance insights, and optimization recommendations, that are ultimately presented to or on behalf of third-party advertiser users 14 to inform media buying and campaign strategy decisions.

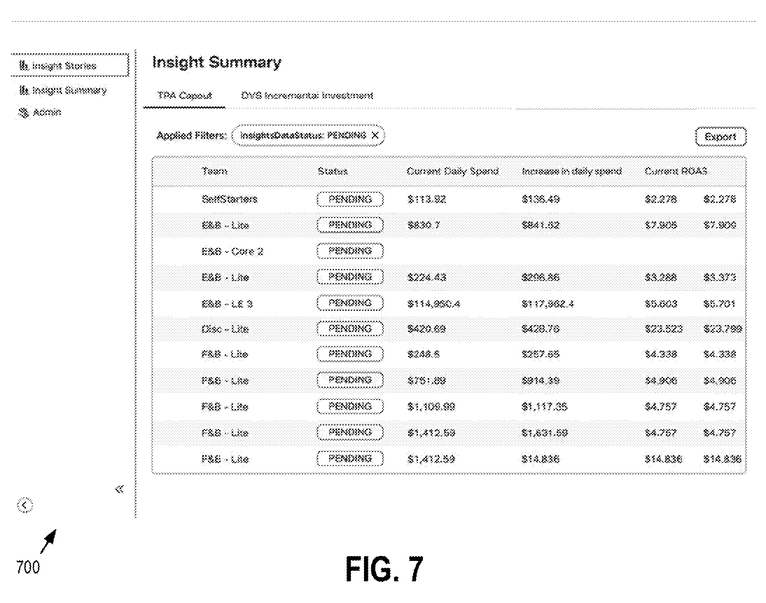

The enterprise user 12 represents a human operator employed by or affiliated with the enterprise that operates the third-party campaign processing system 102. In typical implementations, the enterprise user 12 may be an account manager, sales representative, client services specialist, or other personnel responsible for managing relationships with third-party advertisers and delivering data-driven insights regarding advertising campaign performance. The enterprise user 12 interacts with the third-party campaign processing system 102 through one or more user interfaces (described in greater detail with respect to FIGS. 7-9) to review automatically generated presentation content, approve content for delivery to third-party advertiser users 14, reject content that fails quality standards, and provide structured or unstructured feedback to improve future content generation. In some embodiments, the enterprise user 12 does not directly create presentation content through manual data retrieval, analysis, visualization generation, and narrative drafting. Instead, the enterprise user 12 serves as a quality gatekeeper in a human-in-the-loop workflow, validating AI-generated content before it reaches third-party advertiser users 14.

The third-party advertiser user 14 represents an external entity, such as a brand advertiser, product manufacturer, advertising agency representative, or other party that purchases advertising services from the enterprise operating the third-party campaign processing system 102. The third-party advertiser user 14 is designated as “third-party” to indicate that the advertiser is external to the enterprise and operates independently from the enterprise's organizational structure, though the advertiser maintains a commercial relationship with the enterprise through the purchase of advertising products or services. In typical use cases, the third-party advertiser user 14 receives data-driven presentation content—such as slide decks, reports, email summaries, or in-application notifications—that have been generated by the third-party campaign processing system 102 and approved by an enterprise user 12. The presentation content provides the third-party advertiser user 14 with actionable insights regarding campaign performance, including metrics such as return on advertising spend (ROAS), daily spend recommendations, sales outcomes, customer consideration metrics, and opportunities for campaign optimization. Based on these insights, the third-party advertiser user 14 may make media buying decisions, adjust campaign budgets, modify targeting strategies, extend campaign flight durations, or take other actions intended to improve advertising effectiveness and business outcomes.

Throughout this disclosure, the term “subject entity” refers to the advertiser account, customer entity, client organization, or other business entity for whom data-driven presentation content is being generated by the third-party campaign processing system 102. In the exemplary retail media platform implementation described herein, the subject entity typically corresponds to a third-party advertiser user 14, such as a brand manufacturer, product advertiser, or advertising agency that maintains an account with the enterprise operating the third-party campaign processing system 102.

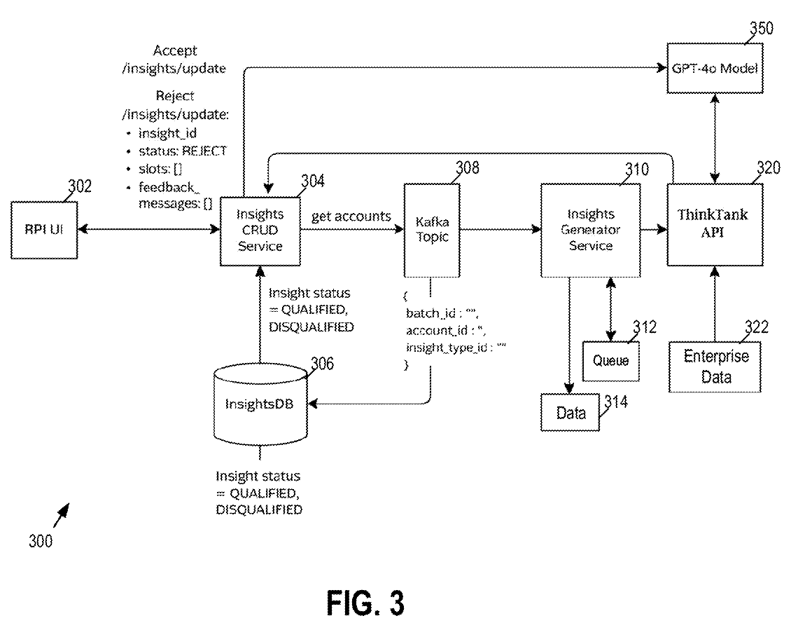

The third-party campaign processing system 102 is implemented using computing infrastructure that provides the multi-agent content generation workflows, feedback validation mechanisms, and continuous improvement loops described throughout this disclosure. The third-party campaign processing system 102 may be implemented as a distributed computing system comprising multiple interconnected servers, microservices, application programming interfaces (APIs), databases, message queues, and user interface components, as described in greater detail with respect to FIGS. 3-4 and FIG. 10. In some embodiments, the third-party campaign processing system 102 is operated by a retail media platform, such as a retailer's advertising business unit, that provides advertising opportunities to brand manufacturers and other advertisers seeking to reach the retailer's customer base. However, the system architecture and methods disclosed herein are not limited to retail media applications and may be adapted for use in other enterprise contexts requiring automated generation and refinement of data-driven presentation content.

The third-party campaign processing system 102 is communicatively coupled to one or more data sources that provide the underlying data used for insight generation and presentation content creation. As illustrated in FIG. 1, these data sources may include, but are not limited to: campaign data 20, item and sales data 22, and advertiser data 24. Each data source may be implemented as one or more databases, data warehouses, data lakes, or other structured or unstructured data repositories accessible via database queries, API calls, or other data retrieval mechanisms.

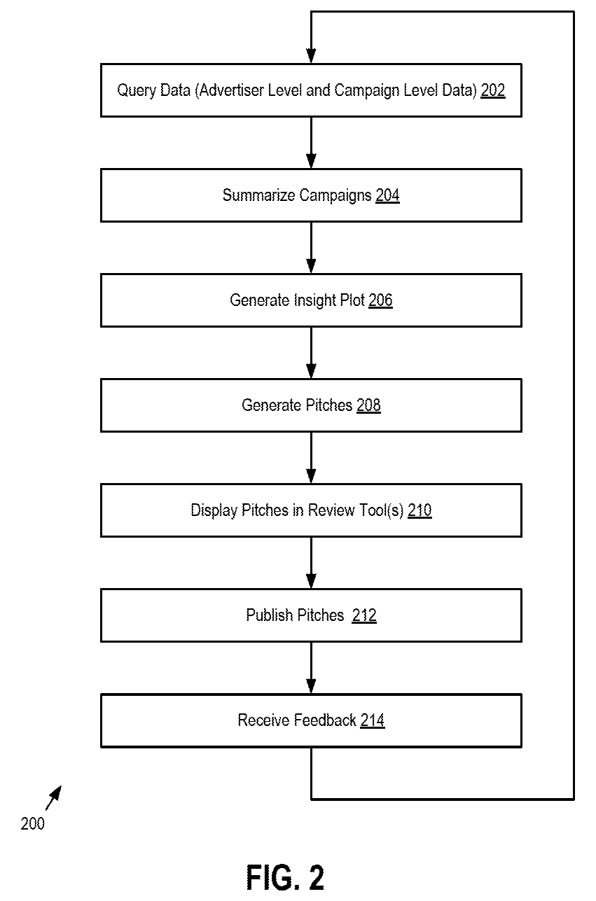

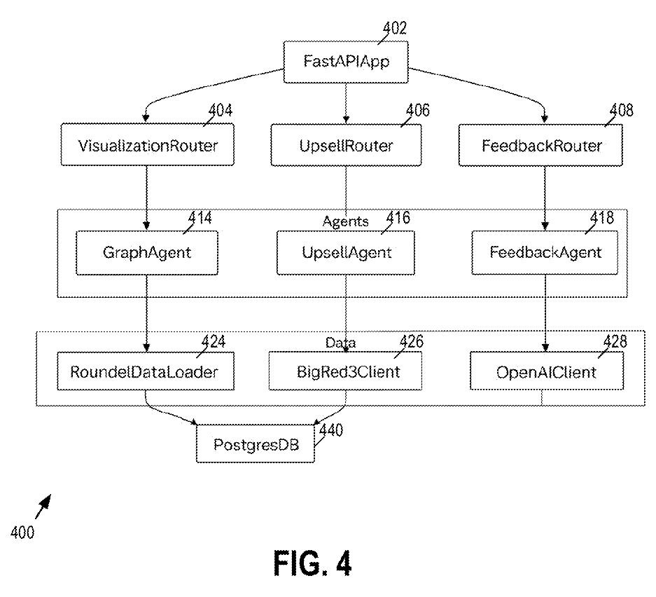

The campaign data 20 comprises granular performance metrics and metadata associated with individual advertising campaigns executed on behalf of third-party advertiser users 14. Campaign data 20 may include, without limitation: campaign identifiers, campaign names, campaign flight start and end dates, remaining flight duration, daily advertising spend amounts, cumulative spend amounts, impression counts, click counts, conversion events, attributed sales revenue, return on advertising spend (ROAS) calculations, cost-per-click (CPC) metrics, cost-per-acquisition (CPA) metrics, campaign status indicators (e.g., active, paused, completed), targeting parameters (e.g., product categories, keywords, audience segments), and creative asset identifiers. In some embodiments, campaign data 20 is structured to support both real-time and historical analysis, enabling the data retrieval agent (described with respect to FIGS. 2 and 4) to query performance metrics over specified date ranges and identify temporal trends, seasonality patterns, and performance deviations. The campaign data 20 may be updated continuously or periodically as advertising campaigns execute, ensuring that generated insights reflect current campaign performance.

The item and sales data 22 comprises product-level information and transaction data that enables attribution of advertising campaign performance to specific products, product categories, or sales outcomes. Item and sales data 22 may include, without limitation: product identifiers (e.g., SKUs, UPCs), product names, product descriptions, product categories and subcategories, product prices, inventory availability, sales transaction records, units sold, transaction timestamps, sales revenue, customer identifiers (in hashed or anonymized form), and attribution linkages connecting advertising exposures or clicks to subsequent purchase transactions. In retail media contexts, the item and sales data 22 may draw from the retailer's point-of-sale systems, e-commerce platforms, and customer relationship management (CRM) systems, providing closed-loop measurement capabilities that link advertising exposure to actual purchase behavior. This closed-loop measurement enables calculation of ROAS and other performance metrics that directly quantify the revenue impact of advertising spend, which may be incorporated into the data-driven presentation content generated for third-party advertiser users 14.

The advertiser data 24 comprises entity-level information and aggregated metrics associated with third-party advertiser accounts. Advertiser data 24 may include, without limitation: advertiser identifiers, advertiser names, advertiser industry classifications or vertical categories, account creation dates, account status indicators, aggregate spend amounts across all campaigns, aggregate sales revenue attributed to all campaigns, lifetime ROAS calculations, account tier or segment classifications (e.g., strategic accounts, mid-market accounts, self-service accounts), assigned account manager identifiers linking to enterprise user 12 records, historical engagement records documenting prior insight deliveries and advertiser responses, and advertiser preference profiles capturing learned preferences regarding presentation formats, visualization styles, metric priorities, and communication frequency. In some embodiments, advertiser data 24 also stores advertiser-specific feedback patterns derived from prior rejections of generated presentation content, as described with respect to the feedback synthesis engine in FIGS. 2-3 and the multi-level aggregation mechanisms disclosed herein. These learned preferences enable the system to automatically customize future content generation for specific third-party advertiser users 14 without requiring manual configuration by enterprise users 12.

The third-party campaign processing system 102 is further communicatively coupled to one or more large language models (LLMs) 50. The LLM 50 comprises an artificial intelligence system based on transformer neural network architectures or other deep learning architectures capable of processing natural language inputs and generating natural language outputs. In some embodiments, the LLM 50 is a generative pre-trained transformer model, such as GPT-4, GPT-4o, GPT-4-turbo, or subsequent versions thereof, developed by OpenAI or other AI research organizations. Alternatively or additionally, the LLM 50 may comprise other large-scale language models such as Claude (developed by Anthropic), Llama (developed by Meta), PaLM or Gemini (developed by Google), or proprietary enterprise language models fine-tuned for specific domain applications.

The LLM 50 may be deployed in multiple architectural configurations relative to the third-party campaign processing system 102. In a first configuration, the LLM 50 may be an external LLM operated by a third-party AI service provider and accessed by the third-party campaign processing system 102 via API calls over a network connection, such as the Internet or a dedicated private network. For example, the third-party campaign processing system 102 may invoke the LLM 50 by transmitting HTTP or HTTPS requests to an external API endpoint (e.g., the OpenAI API, Anthropic API, or other cloud-based AI service), including prompt text and configuration parameters in the request payload, and receiving generated text responses in the API response payload. This external LLM configuration enables the enterprise to leverage state-of-the-art language models without the need to train, host, or maintain the models internally, though it introduces dependencies on external service availability, API rate limits, and per-token usage costs.

In a second configuration, the LLM 50 may be an internal LLM operated by the enterprise within its own computing infrastructure, such as on-premises servers or private cloud environments dedicated to the enterprise's exclusive use. The internal LLM may comprise an open-source language model (e.g., Llama, Mistral) or a proprietary model developed or fine-tuned by the enterprise, deployed on the enterprise's own hardware or private cloud instances. This internal LLM configuration provides the enterprise with greater control over model behavior, data privacy, inference latency, and operational costs, as the enterprise is not subject to external service rate limits or per-token pricing. However, the internal LLM configuration requires the enterprise to invest in specialized hardware (e.g., GPUs or TPUs), model deployment infrastructure, and ongoing model maintenance and updates.

In a third configuration, the LLM 50 may be a hybrid combination of external and internal language models, wherein different agents or workflow steps within the third-party campaign processing system 102 invoke different LLM instances based on task requirements, performance characteristics, cost considerations, or data sensitivity. For example, the system may invoke a powerful external LLM (e.g., GPT-4o) for complex reasoning tasks such as feedback validation and synthesis agent operations, while invoking a smaller, faster internal LLM for high-volume, lower-complexity tasks such as data summarization or template-based text generation. The hybrid configuration may also implement fallback mechanisms wherein the system defaults to an internal LLM when external LLM services are unavailable due to network issues, service outages, or rate limit exhaustion. In some embodiments, the third-party campaign processing system 102 includes an LLM abstraction layer (also referred to as a “Think Tank API” in some embodiments, as described with respect to FIG. 3) that decouples upstream application logic from specific LLM implementations, enabling transparent switching between external, internal, or hybrid LLM configurations without requiring modifications to agent code or workflow orchestration logic.

The third-party campaign processing system 102 invokes the LLM 50 at multiple points throughout the multi-agent content generation workflow and feedback validation processes. For example, the LLM 50 may be invoked by: (i) a data retrieval agent to interpret complex query requirements and generate structured database queries or API calls for retrieving campaign data 20, item and sales data 22, and advertiser data 24; (ii) a filtering agent to reason about campaign eligibility based on temporal constraints (e.g., campaigns with less than 15 days remaining in flight duration) and optimization potential criteria; (iii) a visualization generation agent to analyze retrieved data, select appropriate chart types (e.g., bar charts, line charts, comparison plots), and generate textual descriptions accompanying visualizations to enable downstream reasoning; (iv) a synthesis agent to generate compelling narrative text, such as campaign spend pitch recommendations and persuasive slide titles, that integrate data insights with natural language storytelling; and (v) a feedback validation engine to analyze unstructured feedback provided by enterprise users 12, extract structured feedback elements (rejection reasons, rejection categories, rejection perspectives), validate feedback completeness and specificity, and generate contextual follow-up questions when feedback is insufficient. These LLM invocations are described in greater detail with respect to FIGS. 2-4.

The communication pathways illustrated in FIG. 1 represent logical data flows and may be implemented using various networking technologies, protocols, and architectural patterns. Communication between the enterprise user 12 and the third-party campaign processing system 102 may occur via web-based user interfaces accessed through standard web browsers, native mobile or desktop applications, or other client-server architectures. Communication between the third-party campaign processing system 102 and the data sources 20, 22, 24 may occur via database connection protocols (e.g., JDBC, ODBC), RESTful APIs, GraphQL queries, message queue systems, or other data integration mechanisms. Communication between the third-party campaign processing system 102 and the LLM 50 may occur via RESTful API calls over HTTPS, gRPC connections, WebSocket connections for streaming responses, or direct function calls for internally hosted models. In some embodiments, the third-party campaign processing system 102 implements caching mechanisms to reduce redundant data retrievals from data sources 20, 22, 24 and to minimize costly LLM API invocations by reusing previously generated content when input conditions have not changed.

The system environment 100 illustrated in FIG. 1 enables a technical workflow in which the enterprise user 12 benefits from automated, AI-powered generation of data-driven presentation content without requiring manual data retrieval, analysis, visualization creation, or narrative drafting, while maintaining human oversight and quality control over content delivered to third-party advertiser users 14. The third-party advertiser user 14 benefits from receiving frequent, consistent, data-driven insights that are automatically generated at scale and customized based on learned preferences, without requiring the enterprise to scale its human workforce proportionally with advertiser account growth. The third-party campaign processing system 102 implements a continuous improvement loop wherein feedback from enterprise users 12 regarding rejected content is systematically collected, validated, aggregated, and applied to enhance future content generation, creating a learning system that becomes increasingly accurate and personalized over time. The modular integration with one or more LLMs 50, which may be external, internal, or a hybrid combination thereof, provides the enterprise with flexibility to optimize for cost, performance, data privacy, and service reliability based on evolving business requirements and technological capabilities.

FIG. 2 illustrates an example high-level process flow 200 for automated insight generation and feedback handling in accordance with embodiments of the present disclosure. The process flow 200 depicts the sequential operations performed by the third-party campaign processing system 102 (described with respect to FIG. 1) to generate data-driven presentation content, present the content for human review, and collect feedback for continuous improvement. The process flow 200 represents an end-to-end workflow from initial data retrieval through final content publication or feedback collection, enabling automated generation of sales stories, campaign insights, and optimization recommendations at scale while maintaining human-in-the-loop quality control.

The process flow 200 implements a multi-agent architecture wherein specialized processing components (also referred to as “agents”) perform discrete, focused tasks rather than attempting to accomplish all reasoning and generation operations through a single monolithic prompt or processing step. This multi-agent approach provides several technical advantages: (i) each agent can be independently optimized and refined without requiring modifications to other agents in the workflow; (ii) errors or quality issues can be isolated to specific agents, facilitating more efficient debugging and improvement; (iii) different agents can invoke different LLM models, API endpoints, or processing logic based on the specific requirements of their tasks; and (iv) the modular architecture enables reuse of agent components across multiple parent workflows or applications. The multi-agent architecture described with respect to FIG. 2 is implemented through the more detailed system architectures illustrated in FIGS. 3-4.

At step 202, the process flow 200 begins with querying data, specifically retrieving advertiser-level data and campaign-level data from one or more data sources. This step is performed by a data retrieval agent (also referred to as a “data analyst agent” in some embodiments) that is configured to execute structured queries against the campaign data 20, item and sales data 22, and advertiser data 24 described with respect to FIG. 1. The data retrieval agent receives input parameters identifying the subject of the insight generation request, such as an advertiser identifier corresponding to a specific third-party advertiser user 14, and constructs appropriate database queries, API calls, or data warehouse queries to retrieve the necessary data for subsequent analysis.

In example embodiments, the data retrieval operation at step 202 produces two distinct data structures: an advertiser-level data frame and a campaign-level data frame. The advertiser-level data frame comprises aggregated metrics and summary statistics calculated across all campaigns associated with the identified advertiser over a specified time period (e.g., the most recent 30 days, 60 days, 90 days, or other configurable time windows). The advertiser-level data may include, without limitation: total advertising spend across all campaigns, total attributed sales revenue, aggregate return on advertising spend (ROAS), number of active campaigns, number of completed campaigns, average campaign performance metrics, historical trend data, advertiser industry classification, account tier or segment designation, and other entity-level characteristics relevant to insight generation.

The campaign-level data frame includes granular, campaign-specific metrics for each individual advertising campaign associated with the identified advertiser. Unlike the advertiser-level data which presents aggregated views, the campaign-level data enables analysis of individual campaign performance, identification of high-performing and underperforming campaigns, and generation of campaign-specific recommendations. The campaign-level data may include, without limitation: campaign identifiers and names, campaign flight start dates and end dates, remaining flight duration (e.g., number of days until campaign completion), daily advertising spend amounts, cumulative spend to date, impression counts, click-through rates, conversion events, attributed sales revenue, campaign-specific ROAS calculations, targeted product categories or keywords, campaign status indicators, and historical performance trends for each campaign. The campaign-level data provides the granular information necessary for the filtering agent (described with respect to step 204) to identify specific campaigns suitable for inclusion in generated presentation content.

In some embodiments, the data retrieval agent at step 202 may invoke an LLM 50 (described with respect to FIG. 1) to interpret complex query requirements expressed in natural language, translate business logic into structured database queries, or perform intelligent data aggregation based on the specific insight types being generated. Alternatively or additionally, the data retrieval agent may execute predefined query templates with parameterized inputs, avoiding LLM invocation for routine data retrieval operations to reduce latency and computational costs. The retrieved data frames are passed as inputs to subsequent agents in the workflow, enabling downstream reasoning, filtering, visualization generation, and synthesis operations.

At step 204, the process flow 200 proceeds to summarize campaigns by applying eligibility criteria to the campaign-level data retrieved at step 202. This step is performed by a filtering agent (also referred to as a “campaign eligibility tool” in some embodiments) that evaluates each campaign against predefined business rules to determine whether the campaign qualifies for inclusion in the generated presentation content. The filtering operation serves to focus the insight generation process on campaigns where actionable recommendations can be made and where sufficient time remains for the third-party advertiser user 14 to implement recommended actions before campaign conclusion.

In some embodiments, a filtering agent at step 204 applies a temporal constraint as a first eligibility criterion. Specifically, the filtering agent may identify campaigns having less than a predefined threshold of remaining flight time, such as less than 15 days remaining until the campaign's scheduled end date. This temporal constraint reflects a strategic timing consideration: campaigns nearing conclusion have accumulated sufficient performance data to enable statistically meaningful analysis, while still providing adequate time for advertisers to take corrective or optimization actions (e.g., increasing daily spend, extending flight duration, adjusting targeting parameters) before the campaign ends. Campaigns with more than the threshold remaining flight time may be excluded from the current insight generation cycle, as presenting recommendations too early in the campaign lifecycle may be premature or based on insufficient data. Conversely, campaigns that have already concluded or that have less than a minimum threshold (e.g., less than 3 days remaining) may also be excluded, as there is insufficient time remaining to implement recommendations.

In addition to temporal constraints, the filtering agent at step 204 may apply a performance optimization potential criterion as a second eligibility factor. This criterion evaluates whether a given campaign demonstrates actual potential gains available to the advertiser—that is, whether the campaign exhibits characteristics indicating that optimization actions (such as increased spend, extended flight duration, or targeting adjustments) are likely to yield measurable performance improvements. The performance optimization potential may be assessed by comparing the campaign's actual performance metrics (e.g., ROAS, conversion rate, sales per day) against expected or benchmark performance levels derived from historical data, similar campaigns, advertiser averages, or industry standards. Campaigns performing at or above expected levels may be excluded from certain insight types focused on improvement opportunities, while campaigns underperforming relative to benchmarks may be prioritized for inclusion in optimization-focused presentations.

The output of step 204 may include a filtered subset of qualifying campaigns that satisfy the applied eligibility criteria. This filtered data set is significantly smaller than the complete campaign-level data retrieved at step 202, enabling more focused analysis and reducing computational overhead for subsequent visualization and synthesis operations. The filtering agent may also generate summary statistics characterizing the qualifying campaigns, such as: total number of qualifying campaigns, aggregate metrics across qualifying campaigns (e.g., total spend, total attributed sales), average performance metrics for the qualifying set, and identification of the highest-priority campaign or campaigns for featured presentation. These summary statistics may be included in the presentation content or used to inform the synthesis operations described with respect to step 208.

At step 206, the process flow 200 proceeds to generate insight plots (also referred to as visualizations, charts, or graphs) that provide visual representations of the data and support the narrative recommendations that will be generated in subsequent steps. This step is performed by a visualization generation agent configured to reason about appropriate chart types, select relevant data points, create graphical representations, and generate accompanying textual descriptions that enable downstream agents to understand and incorporate the visualizations into cohesive presentation content.

In some embodiments, the visualization generation agent at step 206 receives as input: (i) the advertiser-level data frame from step 202, (ii) the campaign-level data frame from step 202, (iii) the filtered subset of qualifying campaigns from step 204, and (iv) one or more predefined insight descriptions that specify the type of analysis to perform and the general category of visualization to generate. The insight descriptions may include structured templates or specifications that define analytical objectives such as: comparing current performance to potential performance under different spending scenarios; identifying trends in daily sales over time; comparing ROAS across multiple campaigns; highlighting the relationship between advertising spend and sales outcomes; or other analytical narratives commonly used in sales stories and campaign performance presentations.

The visualization generation agent employs an LLM 50 (described with respect to FIG. 1) to reason through the insight description, examine the retrieved data, identify the most relevant data points and metrics for the specified analysis, and determine an appropriate chart type that effectively communicates the intended insight. For example, when generating an insight focused on return on advertising spend (ROAS) as a key metric, the agent locates ROAS values within the qualifying campaign data, identifies comparison points (such as current ROAS versus potential ROAS under an optimized spending scenario), and creates a visualization—such as a bar chart, line chart, or comparison plot—that clearly represents this comparison. The LLM's reasoning capabilities enable flexible, context-aware visualization selection rather than rigid, rule-based chart type assignment.

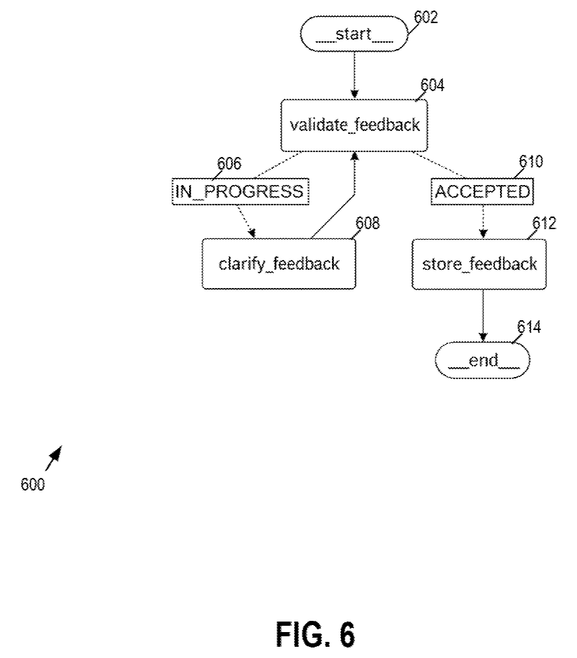

In some examples, the visualization generation at step 206 includes the generation of textual descriptions accompanying each visualization. These textual descriptions serve multiple technical purposes: (i) they enable the synthesis agent (described with respect to step 208) to reason about the visualization content when generating narrative text and slide titles, as the LLM processing the synthesis step receives the textual description rather than attempting to interpret graphical pixel data; (ii) they provide structured metadata that can be used for slot-level feedback aggregation and pattern recognition (described with respect to FIG. 6 and step 214); (iii) they support accessibility requirements by providing text alternatives to visual content; and (iv) they enable alternative rendering formats such as email summaries or text-based notifications where graphical visualizations may not be displayed. The textual descriptions typically include information such as: the metrics being visualized, the comparison being made, the key numerical values, the insight or conclusion that the visualization supports, and the relationship to the overall recommendation.

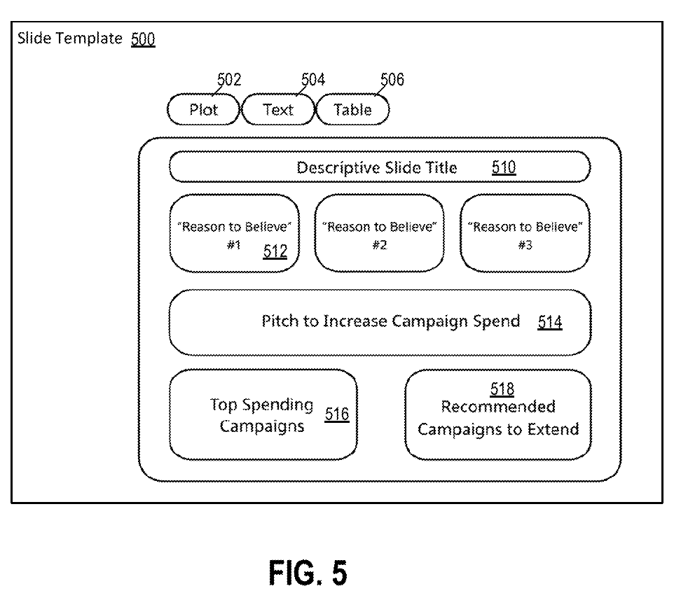

The visualization generation at step 206 may produce multiple visualizations for a single presentation, often referred to as “reason to believe plots” that provide evidentiary support for the central recommendation. For example, a presentation recommending increased campaign spending might include: (i) a visualization showing the relationship between historical spend levels and sales outcomes, demonstrating that higher spend correlates with higher sales; (ii) a visualization comparing current ROAS to projected ROAS under the recommended spending increase; and (iii) a visualization showing the gap between current daily sales and potential daily sales achievable through the recommendation. Each of these visualizations occupies a discrete content slot in the final presentation (described with respect to FIG. 5) and includes its own textual description enabling independent processing, feedback collection, and potential regeneration.

In some embodiments, the visualization generation agent, at step 206, is implemented as an independent subgraph or sub-workflow that can be invoked by multiple parent workflows beyond the primary insight generation process. This modular architecture enables reuse of the sophisticated data visualization capabilities across other applications, such as query bots, reporting tools, dashboard generators, or ad-hoc analysis systems. The extraction of visualization generation into a reusable component represents an architectural pattern wherein commonly needed capabilities are implemented as shared services rather than duplicated across multiple implementations.

At step 208, the process flow 200 proceeds to generate pitches, also referred to as narrative recommendations, campaign spend pitches, or synthesis text. This step may be performed, for example, by a synthesis agent that combines all previously generated elements—including the advertiser-level summary data, campaign-level summary data, filtered qualifying campaigns, generated visualizations, and accompanying textual descriptions—into cohesive, persuasive narrative content suitable for presentation to third-party advertiser users 14. The synthesis agent employs natural language generation capabilities provided by an LLM 50 to craft messaging that integrates quantitative data insights with strategic recommendations in a compelling, action-oriented format.

In example embodiments, the synthesis agent at step 208 generates multiple textual components that together constitute the complete presentation content. In some embodiments, these components include, without limitation: (i) a campaign spend pitch comprising one or more paragraphs of narrative text that explain the recommended action (e.g., “Increase daily ad spend by $162.50 to boost daily sales by $880.20 and improve ROAS by 1.85%”), articulate the business rationale for the recommendation (e.g., “Reach more high intent customers and generate more sales!”), present supporting evidence drawn from the generated visualizations, and create a sense of urgency or opportunity that motivates advertiser action; and (ii) a compelling slide title that synthesizes the key message into a concise, attention-grabbing headline that encapsulates the central recommendation or insight (e.g., “Increase Campaign Spend to Maximize Sales Opportunity” or “Extend High-Performing Campaigns to Drive Additional Revenue”).

The synthesis operation at step 208 represents a reasoning task in which the LLM must balance multiple considerations simultaneously: technical accuracy of data representation, persuasiveness of messaging, clarity for the intended audience (third-party advertiser users 14 who may have varying levels of analytical sophistication), consistency between visualizations and narrative text, alignment with the enterprise's brand voice and sales methodology, and adherence to any advertiser-specific preferences learned from prior feedback (described with respect to step 214 and FIGS. 3, 6).

In some embodiments, the synthesis agent at step 208 incorporates feedback-derived constraints or preferences when generating narrative content. For example, if prior feedback from an enterprise user 12 indicated that a particular advertiser dislikes certain metric representations or prefers specific messaging styles, this preference information may be automatically integrated into the synthesis agent's instructions, causing the LLM to proactively adjust the generated narrative to align with known advertiser preferences. This feedback integration capability implements a form of continuous learning wherein the system becomes increasingly personalized and accurate over time as it accumulates structured feedback data. The feedback synthesis mechanisms that enable this capability are described in greater detail with respect to FIGS. 3 and 6.

The output of step 208 may include a complete set of presentation content elements organized into discrete, independently addressable content slots. As described with respect to FIG. 5, the slot-based architecture organizes presentation content into modular units, each containing either a visualization (generated at step 206), a text field (generated at step 208), or a data table (which may be generated by the synthesis agent or other specialized agents). The slot-based organization enables several important capabilities: (i) granular user feedback at the slot level rather than requiring page-level or presentation-level feedback; (ii) selective regeneration of individual problematic slots without affecting correctly generated slots; (iii) independent optimization of generation logic for different slot types; and (iv) flexible template modification by adding, removing, or rearranging slots without requiring fundamental changes to the generation workflow.

At step 210, the process flow 200 proceeds to display the generated pitches (presentation content) in one or more review tools, presenting the content to enterprise users 12 for human review and quality validation. This step implements the human-in-the-loop quality control mechanism that distinguishes the present disclosure from fully automated content generation systems that lack human oversight. The review tools comprise user interfaces (described in greater detail with respect to FIGS. 7-9) that enable enterprise users 12, such as account managers or sales representatives, to view generated presentation content, assess its appropriateness for delivery to specific third-party advertiser users 14, and make approval or rejection decisions.

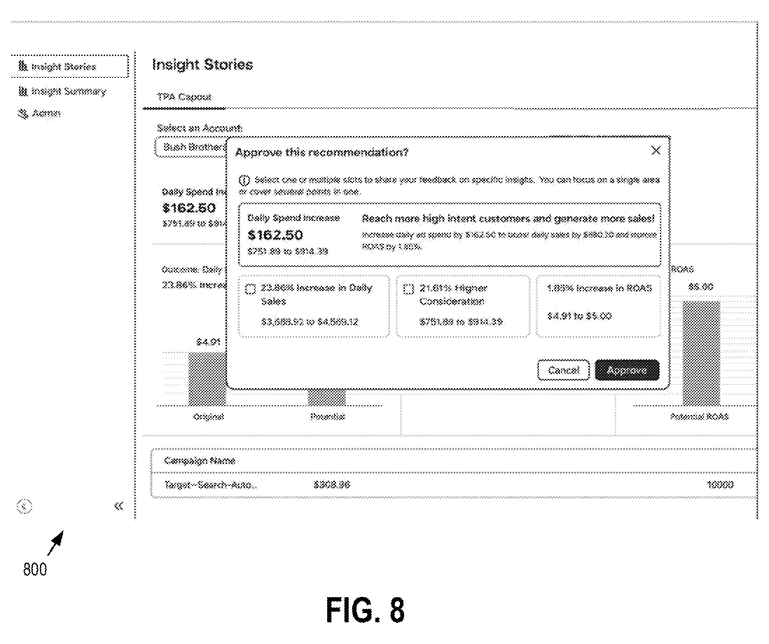

In some embodiments, the display at step 210 presents presentation content through multiple interface views. A first interface view may comprise an insight summary view (illustrated in FIG. 7) that displays a list of advertisers for whom presentation content has been generated, along with status indicators showing which insights are pending review, which have been approved (qualified), and which have been rejected (disqualified). This summary view enables enterprise users 12 to efficiently triage their review workload, prioritizing advertisers with upcoming client meetings or strategic importance. A second interface view may include a detailed insight review interface (illustrated in FIG. 8) that presents the complete presentation content for a selected advertiser, displaying all generated content slots including visualizations, narrative text, data tables, slide titles, and supporting evidence in a format approximating the final presentation layout.

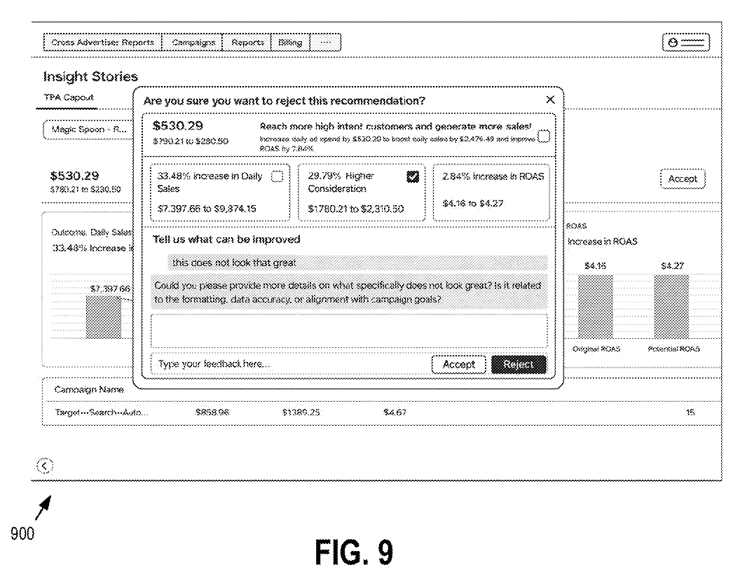

The review interface at step 210 provides enterprise users 12 with intuitive controls for approving or rejecting generated content. In some embodiments, the interface includes: (i) an approval button (also referred to as an “Accept” button) that, when activated, transitions the presentation content to a “qualified” status, indicating that the content has passed human quality review and is approved for delivery to the third-party advertiser user 14; and (ii) a rejection button (also referred to as a “Reject” button) that, when activated, initiates the feedback collection workflow described with respect to step 214 and FIGS. 6 and 9. The interface may also provide a download function that enables enterprise users 12 to export approved content in presentation formats such as Microsoft PowerPoint (.pptx), PDF, or other formats suitable for client delivery.

In some embodiments, the display at step 210 includes content preview capabilities that enable enterprise users 12 to review presentation content without requiring full file downloads or opening external applications. For example, the interface may render visualizations, text content, and layout directly within a web browser or native application interface, enabling rapid review of multiple insights in succession. The preview capability reduces friction in the review workflow and enables enterprise users 12 to process larger volumes of generated content in shorter time periods compared to traditional workflows requiring manual download and opening of individual presentation files.

While the multi-agent workflow (steps 202-208) automates the labor-intensive tasks of data retrieval, analysis, visualization creation, and narrative generation—potentially saving multiple hours per presentation compared to manual creation—the human review at step 210 ensures that only content meeting enterprise quality standards and appropriate for the specific advertiser context is delivered to third-party advertiser users 14.

At step 212, the process flow 200 proceeds to publish approved pitches, making the qualified presentation content available for delivery to third-party advertiser users 14. This step is triggered when an enterprise user 12 approves presentation content at step 210, causing the system to transition the content status from “pending review” to “qualified” and enabling downstream distribution processes. The publication step 212 represents the successful completion of the primary workflow path, wherein AI-generated content has been validated by human review and is ready for client-facing use.

In some embodiments, the publication at step 212 may include making the presentation content available for download by the enterprise user 12 who approved it, enabling that user to incorporate the content into scheduled client meetings, email communications, or other advertiser engagement activities according to their discretion and timing. The publication may generate a presentation file in a specified format (e.g., PowerPoint, PDF) that the enterprise user 12 can download, further customize if desired (e.g., adding advertiser-specific branding, additional slides, or personalized messaging), and deliver to the third-party advertiser user 14 through appropriate communication channels.

In alternative or additional embodiments, the publication at step 212 may include automated or semi-automated distribution of the presentation content to third-party advertiser users 14 through multiple delivery channels. For example, the system may: (i) automatically generate and send an email to the third-party advertiser user 14 containing the presentation file as an attachment or a link to an access-controlled download location; (ii) post the presentation content to a self-service portal or dashboard where the third-party advertiser user 14 can log in and access insights on-demand; (iii) generate an in-application notification within a platform (such as an advertising management system) alerting the third-party advertiser user 14 that new insights are available for review; or (iv) schedule the content for inclusion in periodic reporting cycles such as weekly or monthly performance reports. The multi-channel distribution capability reflects the architectural flexibility built into the system, wherein the content generation logic is decoupled from the presentation and distribution logic, enabling the same generated insights to be rendered and delivered through multiple formats and channels without requiring regeneration of the underlying content.

The publication step 212 may also trigger recording of metadata for analytics and performance tracking purposes. For example, the system may record: the date and time of publication, the enterprise user 12 who approved the content, the third-party advertiser user 14 to whom the content was delivered, the delivery channel used, and identifiers linking the published content to the specific insight generation execution and underlying data. This metadata enables subsequent analysis of system performance, such as: calculating acceptance rates (percentage of generated insights that are approved versus rejected), measuring time-to-publication (elapsed time from generation to approval), tracking advertiser engagement with delivered insights, and correlating delivered insights with subsequent advertiser actions such as campaign modifications or spending increases. In some embodiments, the system may implement closed-loop measurement wherein the impact of published recommendations on advertiser behavior and campaign performance is tracked and used to refine future insight generation, creating a feedback loop at the business outcome level in addition to the content quality feedback described with respect to step 214.

At step 214, the process flow 200 proceeds to receive feedback when an enterprise user 12 rejects generated presentation content at step 210 rather than approving it for publication. The feedback collection step 214 implements an adaptive, conversational feedback validation system that systematically gathers structured information explaining why the content was rejected, what specific elements were problematic, and what improvements are needed. Unlike traditional feedback mechanisms that rely on static forms or free-text comments that often produce incomplete or unusable feedback, the feedback collection at step 214 employs a feedback bot powered by an LLM 50 to interactively engage with the enterprise user 12, validate feedback quality, and iteratively request clarification until sufficient information is obtained to enable actionable improvements.

When an enterprise user 12 activates the rejection button at step 210, the system presents a feedback collection interface (illustrated in FIG. 9) that displays a summary of the presentation content being rejected and enables granular, slot-level feedback rather than requiring holistic presentation-level feedback. The interface displays each content slot (e.g., each visualization, text field, or data table) as a selectable element, and the enterprise user 12 can select one or more specific slots that are problematic while implicitly indicating that non-selected slots are acceptable. This slot-level granularity provides several advantages: (i) it preserves correctly generated content elements, enabling selective regeneration of only the problematic slots rather than discarding the entire presentation; (ii) it provides precise targeting of feedback to specific generation steps or agents, facilitating more efficient debugging and improvement; (iii) it reduces the cognitive burden on the enterprise user 12, who does not need to provide comprehensive feedback about the entire presentation but can focus on the specific issues they identified; and (iv) it enables more accurate feedback aggregation and pattern recognition, as feedback is associated with specific slot types, visualization types, or text components rather than entire presentations.

The feedback collection interface at step 214 supports multi-modal feedback input, enabling enterprise users 12 to provide feedback through either text input (typing into a text box) or voice input (speaking into a microphone with automatic speech recognition and transcription). The multi-modal capability accommodates different user contexts and preferences: some users may prefer typing for precision and editability, while others may find voice input faster and more natural, particularly when providing detailed explanations or when reviewing content on mobile devices or in contexts where typing is inconvenient. The voice input is automatically transcribed to text using speech recognition technology (which may be provided by the same LLM 50 or by a specialized speech-to-text model), and the transcribed text is processed by the feedback validation engine in the same manner as typed text input.

Upon receiving initial feedback from the enterprise user 12, the system at step 214 invokes a feedback validation engine that employs an LLM 50 to analyze the unstructured feedback and attempt to extract structured feedback elements. The feedback validation process is described in greater detail with respect to FIG. 6, but at a high level, the validation engine attempts to extract: (i) a rejection reason—a clear, concise summary of why the selected slot(s) were rejected; (ii) one or more rejection categories—classifications of the rejection type selected from a predefined taxonomy such as “template issue” (problems with layout, formatting, visualization design, or presentation style), “data issue” (incorrect, outdated, or misleading data values), “content misalignment” (content that doesn't align with advertiser strategy, preferences, or current business context), or “other” (issues not captured by predefined categories); and (iii) a rejection perspective—an identifier distinguishing whether the rejection reflects the enterprise user 12's own assessment of a quality problem (“account owner rejection”) or the enterprise user 12's prediction that the third-party advertiser user 14 would object to the content if presented (“anticipated advertiser rejection”).

If the LLM successfully extracts these structured elements and determines that the feedback satisfies predefined completeness and specificity criteria, the feedback is accepted and persisted to a feedback database (described with respect to FIG. 3) along with the complete conversation history. However, if the feedback validation engine determines that the initial feedback is insufficient—for example, the feedback is too vague (e.g., “this is not good”), lacks specificity about what is wrong, or does not provide enough information to classify the rejection or guide corrective action—the system enters an iterative clarification process in which the LLM generates contextual follow-up questions designed to elicit the missing information.

The iterative clarification process at step 214 implements a conversational interaction pattern wherein: (i) the LLM analyzes the conversation history and the selected rejected slots to identify what information is missing or ambiguous; (ii) the LLM generates a follow-up question specifically designed to elicit the missing information (e.g., “Could you please provide more details on what specifically does not look great? Is it related to the formatting, data accuracy, or alignment with campaign goals?”); (iii) the follow-up question is presented to the enterprise user 12 through the feedback collection interface; (iv) the enterprise user 12 provides a response, which is appended to the conversation history; (v) the feedback validation engine re-analyzes the updated conversation history to determine whether sufficient information has now been obtained; and (vi) if validation still fails, the process repeats with a new follow-up question. This iterative process continues until either validation succeeds or a configurable maximum iteration count is reached.

The maximum iteration count represents a balance between feedback quality and user experience. Each additional iteration increases the chance of obtaining complete, actionable feedback but also increases the burden on the enterprise user 12 and the risk of user frustration or abandonment. In some embodiments, the maximum iteration count is set to 5, meaning the system will ask up to 5 follow-up questions before terminating the clarification process. Regardless of whether validation ultimately succeeds or the maximum iteration count is reached, the system persists all collected feedback and the complete conversation history to the feedback database. Even feedback that never achieved full validation contains signal that may be valuable for future analysis, and the conversation history provides qualitative context that may enable human analysts to extract insights that the automated validation logic missed.

The feedback received at step 214 serves multiple purposes within the continuous improvement architecture of the system. At the most immediate level, feedback regarding specific rejected slots can be used to regenerate those slots with feedback-derived constraints, potentially producing improved content that can be re-submitted for enterprise user review. At an intermediate level, feedback can be aggregated across multiple rejection events to identify patterns associated with specific slot types, visualization types, or advertiser segments, informing updates to templates, visualization generation logic, or data pipelines. At the highest level, feedback can be synthesized across all advertisers and all content types to identify systematic quality issues and generate program-level recommendations for improving the multi-agent workflow, refining LLM prompts, expanding training data, or addressing fundamental architectural limitations. The feedback synthesis mechanisms that implement these multi-level improvement capabilities are described in greater detail with respect to FIGS. 3-4 and 6.

Referring to FIG. 2 overall, in some embodiments, the process flow 200 executes as a scheduled batch process that generates presentation content for multiple advertisers during off-peak processing windows (e.g., overnight), ensuring that content is ready and awaiting human review when enterprise users 12 begin their workday. Alternatively, the process flow 200 may be triggered on-demand in response to specific events such as approaching campaign deadlines, significant performance deviations, or explicit requests from enterprise users 12.

FIG. 3 illustrates an example high-level system architecture 300 for bulk insight generation and feedback processing in accordance with embodiments of the present disclosure. The system architecture 300 depicts the interconnected services, data stores, message queuing infrastructure, and external integrations that collectively implement the multi-agent content generation workflow and adaptive feedback validation system described with respect to FIGS. 1-2. The architecture 300 includes a Premium Insights UI 302, an Insight CRUD Service 304, a Scheduler 306, a Data Queue 308, an Insights Generator Service 310, a GenAI Insight Service 320, a Think Tank API 322, an Insights Database 312, a cache layer 314, and one or more large language models (LLM) 350. These components cooperate to support scheduled batch generation of insights, human review, and structured feedback validation within a scalable, service-oriented environment.

The Premium Insights UI 302 provides an interface through which enterprise users may view generated insights, review detailed content, and submit approval or rejection decisions. User actions are transmitted to the Insight CRUD Service 304, which manages creation, retrieval, updating, and status transitions of insight records stored in the Insights Database 312. The CRUD Service 304 updates insight state information (e.g., pending, qualified, disqualified) and coordinates downstream processing triggered by review actions.

The Scheduler 306 initiates bulk insight generation by identifying advertiser accounts or insight types eligible for processing during a scheduled execution window. Identifiers associated with the generation job are published to the Data Queue 308, which may be implemented as a message queue or streaming platform to support asynchronous and distributed processing. The Insights Generator Service 310 consumes messages from the Data Queue 308 and orchestrates execution of the multi-agent generation workflow, including data retrieval, eligibility filtering, visualization generation, and narrative synthesis.

The GenAI Insight Service 320 manages interactions with one or more LLMs 350 for tasks such as visualization reasoning, narrative synthesis, and feedback validation. The GenAI Insight Service 320 communicates with the Think Tank API 322, which serves as an abstraction layer between application logic and specific LLM implementations. The Think Tank API 322 handles prompt construction, model invocation, response parsing, and model configuration management, thereby enabling substitution or upgrade of LLM 350 without requiring modification of upstream services.

Generated insights, associated metadata, and structured feedback records are persisted in the Insights Database 312. The cache layer 314 may be used to store frequently accessed data, reduce redundant LLM calls, or improve response times during review operations. In combination, the architecture 300 enables scalable, scheduled generation of insights while supporting real-time human review and structured feedback processing, thereby implementing a continuous improvement loop within a distributed enterprise system.

FIG. 4 illustrates an example agent-based application architecture including routing components, specialized agents (e.g., visualization agent, upsell agent, feedback agent), data access components, and integration with external AI services and data stores. The architecture 400 includes an orchestration layer 402 that coordinates routing of tasks among multiple specialized agents and tools. The orchestration layer 402 manages execution order, data flow between agents, and conditional branching logic, thereby enabling modular and extensible workflow design.

In the example shown, the architecture 400 includes a data retrieval agent 404, a campaign eligibility agent 406, and an insight reasoning and visualization agent 408. The data retrieval agent 404 is configured to query enterprise data sources and retrieve advertiser-level and campaign-level datasets required for insight generation. The campaign eligibility agent 406 applies predefined business criteria to filter campaigns based on temporal constraints, optimization potential, or other performance characteristics. The insight reasoning and visualization agent 408 analyzes the filtered data in light of predefined insight descriptions and generates structured visualization outputs, including chart data and associated descriptive metadata.

A synthesis agent 414 receives outputs from the visualization agent 408 and integrates advertiser summaries, campaign summaries, and visualization descriptions into cohesive narrative presentation content. The synthesis agent 414 generates structured elements such as slide titles and recommendation narratives aligned with enterprise sales methodology. The output of the synthesis agent 414 may be formatted into a structured slide representation suitable for storage or rendering.

The architecture 400 further includes a feedback agent 416 and a feedback validation agent 418. The feedback agent 416 collects user-provided rejection input from the review interface and formats the input for analysis. The feedback validation agent 418 employs a large language model to extract structured feedback elements, including rejection reason, rejection category, and rejection perspective. If the feedback is incomplete or ambiguous, the feedback validation agent 418 generates contextual follow-up questions to clarify user intent.

The system 400 also includes a feedback synthesis engine 424, which aggregates structured feedback across multiple insights. The feedback synthesis engine 424 may operate at a slot level to identify recurring issues associated with specific content components, at an advertiser level to detect account-specific preferences, and at a program level to identify systemic generation weaknesses. The aggregated feedback may be provided to a workflow optimization component 426 that generates recommended adjustments to agent logic, template structure, or prompt configuration.

In some embodiments, the workflow optimization component 426 may provide recommendations to an administrative review process 428 for manual approval prior to implementation. In alternative embodiments, certain optimizations may be automatically applied by updating agent instructions, prompt parameters, or template configurations. The architecture 400 may interface with one or more external or internal large language models 440, which support reasoning, synthesis, and feedback validation operations. In some embodiments, LLMs 50, 350, and 440 may refer to the same or different large language model instances.

FIG. 5 illustrates an example slot-based slide template architecture in which presentation content is organized into discrete content slots including visualization slots, text slots, and data table slots. The slide template 500 comprises a plurality of predefined content regions, or slots, each configured to receive a specific type of generated content. By structuring presentation content into modular slots, the system enables selective generation, regeneration, review, and feedback at a granular level rather than at an entire-slide level.

The slide template 500 may include a header region 502 and one or more contextual or descriptive regions 504 and 506 that define the structural framework of the slide. These regions may include static template elements such as branding, layout scaffolding, or instructional placeholders. Within this structural framework, dynamic content is inserted into dedicated content slots generated by the multi-agent workflow described with respect to FIG. 4.

A descriptive slide title slot 510 is configured to receive a synthesized headline generated by the synthesis agent. The title slot 510 typically encapsulates the central recommendation or insight derived from the underlying data analysis. Because the title slot 510 is independently addressable, it may be regenerated or modified without altering other slide components.

One or more evidentiary visualization slots 512 are configured to receive generated data visualizations, such as comparison plots, bar charts, trend graphs, or other graphical representations. Each visualization slot 512 may include associated textual descriptions that summarize the meaning of the chart and support downstream reasoning or accessibility requirements. These visualization slots provide “reason-to-believe” support for the recommended action presented in the slide title and narrative.

A narrative pitch slot 514 is configured to receive synthesized recommendation text, such as a campaign spend pitch or explanatory narrative. The narrative pitch slot 514 integrates advertiser-level summaries, campaign-level metrics, and visualization insights into persuasive, client-ready language. Like other slots, the narrative slot 514 may be independently updated based on feedback without requiring regeneration of visual elements.

The slide template 500 may further include structured data table slots, such as a top spending campaigns slot 516 and a recommended campaigns slot 518. The top spending campaigns slot 516 may present tabular data identifying campaigns with the highest current spend or performance metrics. The recommended campaigns slot 518 may present campaigns identified as having optimization potential or recommended adjustments. These table slots are populated using structured data outputs from upstream agents and may be modified independently in response to feedback.

By organizing presentation content into discrete slots 510, 512, 514, 516, and 518 within the slide template 500, the system enables granular feedback collection, selective regeneration of individual components, and targeted aggregation of slot-level rejection patterns. This slot-based architecture supports flexible template modification, advertiser-specific customization, and continuous improvement of individual content components without requiring wholesale regeneration of the entire slide.

FIG. 6 illustrates an example feedback validation and clarification workflow 600 for processing user-provided rejection input associated with generated presentation content. The workflow 600 is executed in response to a rejection action taken by an enterprise user and is configured to transform unstructured feedback into structured, machine-actionable data suitable for downstream synthesis and optimization.

The workflow 600 begins at step 602, where the system receives rejection input from a user. The rejection input may include identification of one or more rejected content slots and accompanying unstructured feedback provided via text or voice input. Voice input may be transcribed into text prior to processing. The received feedback, along with contextual metadata such as insight identifier, advertiser identifier, slot identifiers, and conversation history, is packaged for validation.

At step 604, the system invokes a feedback validation agent, which may employ a large language model to analyze the unstructured feedback. The validation agent attempts to extract structured feedback elements from the provided input. These structured elements may include, without limitation, a rejection reason summarizing the issue, one or more rejection categories selected from a predefined taxonomy, and a rejection perspective indicating whether the rejection reflects the enterprise user’s own assessment or an anticipated advertiser reaction.

At step 606, the system evaluates whether the extracted structured feedback satisfies predefined validation criteria. Validation criteria may include completeness (e.g., all required fields populated), specificity (e.g., sufficiently detailed rejection reason), and classifiability (e.g., mapping to at least one predefined rejection category). If the feedback satisfies these criteria, the workflow proceeds to acceptance at step 610 and persistence at step 612. If the feedback does not satisfy validation criteria, the workflow transitions to an iterative clarification process.

As part of the iterative clarification process, at step 608, the validation agent generates a contextual follow-up question designed to elicit missing or ambiguous information. The follow-up question may reference the specific rejected slot, the previously provided feedback, or one or more missing structured elements. The generated question is presented to the user through a conversational interface, and the user’s response is appended to the feedback conversation history.

At step 610, the system re-evaluates the updated feedback, including the newly provided clarification, by re-invoking the validation agent. The validation process may be repeated iteratively until the structured feedback satisfies validation criteria or until a configurable maximum number of iterations is reached. The maximum iteration threshold may be defined to balance feedback quality with user experience considerations.

At step 612, once validation succeeds, the structured feedback elements and associated conversation history are persisted to a feedback data store. Persisted data may include the structured rejection reason, rejection categories, rejection perspective, rejected slot identifiers, timestamps, and user identifiers. This structured representation enables downstream aggregation, analytics, and workflow optimization.

If the maximum iteration threshold is reached without satisfying validation criteria, the workflow proceeds to step 614, where the system persists the collected feedback and conversation history in its current form. Even if structured extraction is incomplete, the stored feedback may later be analyzed through aggregation or manual review to identify actionable patterns. The workflow 600 thereby ensures that all rejection input is captured while maximizing the likelihood of obtaining structured, high-quality feedback through adaptive clarification.

FIG. 7 illustrates an example insight summary user interface 700 configured to present generated insights to an enterprise user for review and status management. The interface 700 provides a consolidated, advertiser-level view of generated insights and enables efficient triage of pending review items within a human-in-the-loop workflow. The interface 700 may be implemented as a web-based application, desktop application, or other client-server interface communicatively coupled to the campaign processing system.

The interface 700 includes a listing region that displays a plurality of advertiser entries for which insights have been generated. Each advertiser entry may include identifying information such as advertiser name, account classification, or business segment, along with summary metadata associated with one or more generated insights. The listing may further include filtering and sorting controls enabling the enterprise user to filter insights by insight type, advertiser segment, vertical category, or status designation.

Each advertiser entry in the interface 700 may include one or more status indicators reflecting the current state of associated insights. Status indicators may include, without limitation, “pending review,” “qualified,” or “disqualified” states. These states correspond to lifecycle transitions stored in the insights database and managed by the Insight CRUD Service described with respect to FIG. 3. Visual cues, such as color coding or icons, may be used to differentiate status states and facilitate rapid identification of actionable items.

The interface 700 may additionally display summary metrics associated with each insight, such as current daily spend, recommended daily spend, projected performance change, or other key performance indicators. These summary metrics provide the enterprise user with a high-level preview of the generated recommendation prior to detailed review. In some embodiments, the interface 700 may display counts indicating the number of pending insights per advertiser or the total number of insights awaiting review.

Selection of a particular advertiser entry within the interface 700 transitions the user to a detailed insight review interface, such as that illustrated in FIG. 8. In this manner, the insight summary interface 700 functions as a dashboard view that aggregates insight generation results across multiple advertiser accounts and enables streamlined navigation to detailed content. By organizing insights at an advertiser level with associated status and summary data, the interface 700 supports scalable management of large volumes of automatically generated insights within enterprise environments.

FIG. 8 illustrates an example detailed insight review interface 800 configured to present generated presentation content to an enterprise user for evaluation, approval, or rejection. The interface 800 provides a preview of a generated sales story in substantially the same format in which it will be delivered to a third-party advertiser, thereby enabling the enterprise user to assess content accuracy, persuasiveness, and strategic alignment prior to publication.

The interface 800 includes a content display region in which the structured slide content is rendered according to the slot-based template described with respect to FIG. 5. Displayed elements may include a descriptive slide title, one or more evidentiary visualizations, a narrative recommendation pitch, and one or more structured data tables. Each displayed element corresponds to a discrete content slot generated by the multi-agent workflow, although the slot boundaries may not necessarily be explicitly labeled in the review view. The rendered preview may approximate the final presentation layout, including formatting, branding, and styling consistent with enterprise standards.

The interface 800 further includes user controls enabling lifecycle management of the displayed insight. An approval control, such as an “Accept” button, allows the enterprise user to designate the insight as qualified for publication. Activation of the approval control transmits a signal to the Insight CRUD Service, which updates the insight status in the insights database and enables downstream actions such as download or distribution. In some embodiments, confirmation prompts may be presented prior to finalizing approval to ensure deliberate user action.

A rejection control, such as a “Reject” button, enables the enterprise user to initiate the structured feedback workflow described with respect to FIG. 6. Activation of the rejection control may trigger presentation of a feedback modal interface, such as that shown in FIG. 9, allowing the user to select specific content slots and provide explanatory input. The rejection action transitions the insight into a disqualified state pending feedback validation and storage.

The interface 800 may additionally include export or download controls enabling retrieval of a presentation file, such as a PowerPoint or PDF document, once the insight has been approved. The preview view may support scrolling, pagination, or navigation between multiple generated insights for a given advertiser. By presenting the generated content in a near-final format with clearly accessible approval and rejection controls, the interface 800 implements the human-in-the-loop quality assurance step within the automated insight generation lifecycle.

FIG. 9 illustrates an example feedback collection interface 900 presented to an enterprise user in response to rejection of a generated insight. The interface 900 is configured to collect granular, structured feedback associated with one or more rejected content components and to support adaptive clarification as part of the feedback validation workflow described with respect to FIG. 6. The interface 900 may be implemented as a modal overlay within the detailed insight review interface or as a separate view communicatively coupled to the campaign processing system.

The interface 900 includes a content summary region that displays a textual representation of the generated insight, including summaries of individual content slots. Rather than reproducing full graphical elements, the interface 900 may present descriptive summaries corresponding to each slot, thereby enabling efficient identification of problematic components without requiring full visual rendering. Each slot summary may be accompanied by a selection control, such as a checkbox, enabling the enterprise user to designate one or more specific slots as rejected. This slot-level selection mechanism supports granular feedback and selective regeneration of individual content components.

The interface 900 further includes a feedback input region configured to receive explanatory input from the enterprise user. The input region may include a text entry field for typed feedback and, in some embodiments, a voice input control allowing the user to provide spoken feedback that is transcribed into text. The user may provide free-form input describing the reason for rejection, desired changes, or contextual considerations related to the advertiser account. The interface may optionally display contextual prompts encouraging specificity in the feedback.

Upon submission of initial feedback, the interface 900 may display a conversational interaction region in which follow-up questions generated by the feedback validation agent are presented to the user. These follow-up questions are generated when the system determines that the initial feedback lacks sufficient specificity or structured elements required for validation. The conversational region may display the prior user input and system-generated clarification prompts in a chat-style format, allowing the user to respond iteratively. Each additional response is appended to the conversation history and re-evaluated by the feedback validation engine.

The interface 900 may include visual indicators reflecting validation status, iteration progress, or confirmation of successful feedback capture. For example, once structured feedback elements have been successfully extracted, a confirmation message may be displayed indicating that the rejection reason, rejection category, and rejection perspective have been recorded. If a maximum clarification threshold is reached without satisfying validation criteria, the interface may notify the user that feedback has been saved in its current form.

Through the feedback collection interface 900, the system converts informal rejection input into structured, machine-readable feedback associated with specific content slots. By combining slot-level selection, multi-modal input, and iterative clarification, the interface 900 enables efficient collection of actionable feedback while minimizing user burden.

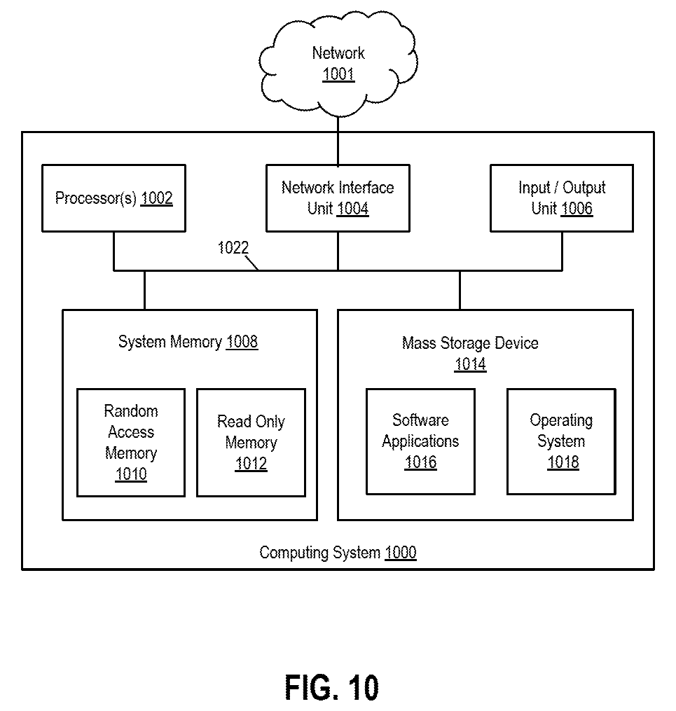

FIG. 10 illustrates an example block diagram of a virtual or physical computing system 1000. One or more aspects of the computing system 1000 can be used to implement the processes described herein.

In the embodiment shown, the computing system 1000 includes one or more processors 1002, a system memory 1008, and a system bus 1022 that couples the system memory 1008 to the one or more processors 1002. The system memory 1008 includes RAM (Random Access Memory) 1010 and ROM (Read-Only Memory) 1012. A basic input/output system that contains the basic routines that help to transfer information between elements within the computing system 1000, such as during startup, is stored in the ROM 1012. The computing system 1000 further includes a mass storage device 1014. The mass storage device 1014 is able to store software instructions and data. The one or more processors 1002 can be one or more central processing units or other processors.

The mass storage device 1014 is connected to the one or more processors 1002 through a mass storage controller (not shown) connected to the system bus 1022. The mass storage device 1014 and its associated computer-readable data storage media provide non-volatile, non-transitory storage for the computing system 1000. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1000.

According to various embodiments of the invention, the computing system 1000 may operate in a networked environment using logical connections to remote network devices through the network 1001. The network 1001 is a computer network, such as an enterprise intranet and/or the Internet. The network 1001 can include a LAN, a Wide Area Network (WAN), the Internet, wireless transmission mediums, wired transmission mediums, other networks, and combinations thereof. The computing system 1000 may connect to the network 1001 through a network interface unit 1004 connected to the system bus 1022. It should be appreciated that the network interface unit 1004 may also be utilized to connect to other types of networks and remote computing systems. The computing system 1000 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the computing system 1000 can store software instructions and data. The software instructions include an operating system 1018 suitable for controlling the operation of the computing system 1000. The mass storage device 1014 and/or the RAM 1010 also store software instructions, that when executed by the one or more processors 1002, cause one or more of the systems, devices, or components described herein to provide functionality described herein. For example, the mass storage device 1014 and/or the RAM 1010 can store software instructions that, when executed by the one or more processors 1002, cause the computing system 1000 to implement third party campaign automated processing and recommendation as described herein.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of specific campaign analysis and recommendation systems, the technologies described herein may be used in conjunction with campaign management systems generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computer-implemented system for automated generation and refinement of structured presentation content, comprising:
(a) a multi-agent content generation workflow including:
(i) a data retrieval agent configured to retrieve multi-level data associated with a subject entity from one or more data sources;
(ii) a filtering agent configured to apply eligibility criteria to the retrieved data to identify qualifying data subsets;
(iii) a visualization generation agent configured to generate one or more data visualizations based on predefined insight descriptions and the qualifying data subsets; and
(iv) a synthesis agent configured to combine the qualifying data subsets, the generated data visualizations, and narrative text into structured presentation content;
(b) a slot-based content architecture in which the structured presentation content is organized into a plurality of discrete content slots, each content slot:
(i) containing content of a defined type selected from a visualization, a text field, or a data table; and
(ii) being independently addressable via a slot identifier;
(c) a user interface configured to:
(i) present the structured presentation content to a user;
(ii) receive a rejection of one or more selected content slots; and
(iii) receive unstructured feedback associated with the selected content slots;
(d) a feedback validation engine configured to:
(i) invoke a large language model (LLM) to analyze the unstructured feedback;
(ii) extract structured feedback including at least a rejection reason and a rejection category; and
(iii) determine whether the structured feedback satisfies predefined validation criteria;
(e) an iterative clarification module configured to, responsive to a determination that the structured feedback does not satisfy the predefined validation criteria:
(i) generate a contextual follow-up question using the LLM;
(ii) receive a response from the user; and
(iii) repeat validation until the structured feedback satisfies the predefined validation criteria or a configurable maximum number of iterations is reached; and
(f) a feedback synthesis engine configured to aggregate structured feedback across a plurality of rejection events associated with the structured content and modify future executions of the multi-agent content generation workflow based on the aggregated feedback,
wherein the system implements a continuous improvement loop in which structured feedback derived from rejected content slots influences subsequent generation of structured presentation content.

2. The system of claim 1, wherein the structured feedback further includes a rejection perspective identifier distinguishing between a user-identified issue and an anticipated third-party issue.

3. The system of claim 1, wherein the rejection category is selected from a predefined taxonomy comprising template issues, data issues, content misalignment issues, and other issues.

4. The system of claim 1, wherein the iterative clarification module is configured to terminate after five iterations and persist collected feedback regardless of validation success.

5. The system of claim 1, wherein the feedback synthesis engine is configured to perform slot-level aggregation by identifying patterns of rejection associated with specific slot identifiers.

6. The system of claim 1, wherein the feedback synthesis engine is configured to perform subject-level aggregation by identifying recurring feedback patterns associated with a particular subject entity and automatically incorporating learned preferences into future content generation for that subject entity.

7. The system of claim 1, wherein the feedback synthesis engine is configured to regenerate only the rejected content slots while preserving non-rejected content slots.

8. The system of claim 1, wherein the visualization generation agent generates textual descriptions associated with each visualization to enable downstream reasoning.

9. The system of claim 1, wherein the user interface supports multi-modal feedback input including both text input and voice input with automatic transcription.

10. The system of claim 1, wherein the multi-agent content generation workflow executes as a scheduled batch process generating presentation content for multiple subject entities.

11. A computer-implemented method for adaptive refinement of automatically generated presentation content, comprising:
(a) generating structured presentation content using a multi-agent workflow, the structured presentation content comprising a plurality of independently addressable content slots;
(b) presenting the structured presentation content to a user;
(c) receiving a rejection of one or more selected content slots and associated unstructured feedback;
(d) invoking a large language model (LLM) to extract structured feedback from the unstructured feedback;
(e) when the structured feedback fails predefined validation criteria, iteratively generating contextual follow-up questions and re-validating feedback until validation succeeds or a configurable maximum iteration count is reached;
(f) persisting the structured feedback; and
(g) modifying future executions of the multi-agent workflow based on structured feedback aggregated across a plurality of rejection events.

12. The method of claim 11, wherein invoking the large language model (LLM) to extract structured feedback further comprises extracting:
(i) a summarized rejection reason,
(ii) at least one rejection category selected from a predefined taxonomy comprising template issues, data issues, content misalignment issues, and other issues, and
(iii) a rejection perspective identifier distinguishing between a user-identified issue and an anticipated third-party issue,
and wherein the iterative generation of contextual follow-up questions comprises identifying missing information elements required for the predefined validation criteria.

13. The method of claim 11, further comprising selectively regenerating only the rejected content slots by re-executing the multi-agent workflow for the rejected content slots while preserving non-rejected content slots without modification, and incorporating the structured feedback as generation constraints during regeneration.

14. The method of claim 11, wherein modifying future executions of the multi-agent workflow based on aggregated structured feedback further comprises:
performing slot-level aggregation by filtering structured feedback by content slot identifier and identifying recurring rejection patterns associated with the content slot identifier; and
performing subject-level aggregation by filtering structured feedback by identifier associated with the subject entity and identifying recurring preference patterns associated with the identifier; and
automatically incorporating modifications responsive to the recurring rejection patterns and recurring preference patterns into subsequent executions of the multi-agent workflow.

15. The method of claim 11, wherein the structured presentation content further comprises, for each generated data visualization, a corresponding textual description that summarizes metrics visualized, key numerical values, and a conclusion supported by the visualization, and wherein the textual description is stored as part of the independently addressable content slot.

16. The method of claim 11, wherein the multi-agent workflow executes as a scheduled batch process generating structured presentation content for a plurality of subject entities, and wherein generated presentation content for each subject entity is persisted in a pending review state prior to presentation to the user.

17. The method of claim 11, wherein modifying future executions of the multi-agent workflow based on aggregated structured feedback further comprises updating one or more of:
(a) a predefined insight description used by the visualization generation agent;
(b) a narrative prompt template used by the synthesis agent; or
(c) eligibility criteria applied by the filtering agent,
such that subsequent structured presentation content reflects recurring rejection patterns identified from the aggregated structured feedback.

18. A computer-implemented system for validating and operationalizing user feedback regarding automatically generated presentation content, comprising:
(a) a content presentation interface configured to:
(i) display presentation content organized into a plurality of discrete content slots, each slot having a slot identifier and a defined content type selected from a visualization, a text field, or a data table;
(ii) receive a user selection identifying one or more rejected content slots; and
(iii) receive unstructured feedback associated with the rejected content slots;
(b) a feedback validation engine comprising a large language model (LLM) configured to:
(i) analyze the unstructured feedback in context of the rejected content slots and a conversation history;
(ii) extract structured feedback including:
(A) a summarized rejection reason,
(B) at least one rejection category selected from a predefined taxonomy comprising template issues, data issues, content misalignment issues, and other issues, and
(C) a rejection perspective identifier distinguishing between user rejection and anticipated third-party rejection;
(c) a validation module configured to determine whether the structured feedback satisfies predefined completeness and specificity criteria;
(d) an iterative clarification module configured to, when the structured feedback fails the predefined completeness and specificity criteria:
(i) generate a contextual follow-up question using the LLM based on analysis of missing information elements;
(ii) append the follow-up question and user response to the conversation history;
(iii) re-invoke the feedback validation engine using the conversation history; and
(iv) terminate the iterative clarification process after a configurable maximum number of iterations;
(e) a feedback persistence layer configured to store:
(i) the structured feedback,
(ii) the rejected slot identifiers,
(iii) the rejection category,
(iv) the rejection perspective identifier, and
(v) the conversation history;
(f) a selective regeneration engine configured to:
(i) regenerate only the rejected content slots by re-executing a content generation workflow with the structured feedback incorporated as generation constraints; and
(ii) preserve non-rejected content slots without modification,
wherein the system adaptively adjusts the number of clarification interactions based on initial feedback quality and implements slot-level regeneration without regenerating the entire presentation content.

19. The system of claim 18, wherein the feedback validation engine is further configured to require the large language model to generate the structured feedback in a predefined structured output format, and wherein the validation module determines satisfaction of the predefined completeness and specificity criteria based on successful parsing of the structured output format.

20. The system of claim 18, wherein the feedback persistence layer further associates stored structured feedback with a subject identifier corresponding to a specific advertiser entity, and wherein the selective regeneration engine is further configured to incorporate aggregated structured feedback associated with the subject identifier into future executions of the content generation workflow for that advertiser entity.
